(19) United States
(12) Patent Application Publication
(10) Pub. No.: US 2004/0054923 A1
(43) Pub. Date: Mar. 18, 2004

(54) Digital rights and content management system and method for enhanced wireless provisioning

(76) Inventors: Tom E. Seago, San Francisco, CA (US); Thomas J. McSweeney, Helena, MT (US)

Correspondence Address: HOGAN & HARTSON LLP, ONE TABOR CENTER, SUITE 1500, 1200 SEVENTEEN ST., DENVER, CO, 80202, US

(21) Appl. No.: 10/232,291

(22) Filed: Aug. 30, 2002

(51) Int. Cl. H04L 9/00

(52) U.S. Cl. 713/201

(57) ABSTRACT

A computer-based method for managing digital rights in a digital content provisioning system. The method includes providing a set of digital content elements that are accessible from a wireless network. Profiles for a plurality of wireless devices are stored in a central repository. The profiles include information that defines the access rights of the wireless devices to the digital content elements. The method continues with receiving a discovery request from one of the wireless devices based on their digital rights information in their profile. In response to the discovery request, a portion of the digital rights information is retrieved and displayed on the requesting wireless device sometimes along with a listing of the devices personal content. The method may then include receiving an update request from the wireless device to update the access rights and in response, updating the profile information for that wireless device.

### BACKGROUND OF THE INVENTION

1. Field of the Invention

The present invention relates, in general, to digital rights in wireless communication networks, and, more particularly, to software, systems, and methods for enabling the management, by a carrier or service provider and by wireless device users or subscribers, of access rights to digital content and of the digital content itself including the storage of digital content for each user or subscriber wireless device at a location(s) remote to the wireless devices, such as in digital rights lockers or client file systems on a provisioning or carrier server or data storage system.

2. Relevant Background

The wireless communication industry has seen explosive growth as illustrated by the total number of cellular phone subscribers recently exceeding 600 million. At the same time, the rapid emergence of the Internet has changed the landscape of modern computing. People have become more and more dependent on the information that is available on the Internet including e-mail and instant messaging, games and entertainment, stock information, street maps, travel and traffic information, weather forecasts, news and much more. Increasingly, people are demanding access to the Internet from their mobile, wireless devices. As a result, the rapid and efficient deployment of Internet services including providing digital content (including wireless applications, Web services, data, and the like) to wireless devices has become a high priority within the wireless communication industry including consumer and embedded device manufacturers who build the diverse wireless devices, service providers or telecommunication carriers who wish to deliver content to their customers over these diverse wireless devices, and content providers who want to create useful and desirable content for the small, resource-constrained wireless devices.

While providing numerous opportunities for device sales and application and content licensing, the large growth of wireless devices and demand for new applications and corresponding content has resulted in a number of practical challenges that must be addressed for the use of wireless devices to continue to expand. The variety of wireless devices continues to grow and may include nearly any computer or electronic communication device that can receive and, typically, transmit digital data in a wireless manner, such as TV set-top boxes, Internet TVs, Internet-enabled screenphones, automobile entertainment and navigation systems, cell phones, pagers, personal organizers, and the like. The small size of wireless devices has been instrumental to the growing popularity as many of the current wireless devices are palm size or smaller and easy to carry, but the small size has resulted in the devices having limited hardware and software or being resource-constrained devices.

For example, many wireless devices have relatively small amounts of data storage (e.g., a few tens or hundreds of kilobytes of memory available for delivered content), are designed for low power consumption with a 16-bit or 32-bit processor, and often have intermittent wireless connections to a wireless network at a limited bandwidth (often 9600 bps or less). The resource constraints on the wireless devices, and particularly, the lack of persistent storage, continue to challenge service and content providers in their attempts to deliver content in an effective and resource and cost-sensitive manner. The devices can only download a limited amount of content at a time for immediate use and typically, can only persistently store an even smaller amount of content. The term provisioning is often used to describe hosting applications and associated resources on a server, allowing client wireless devices to discover suitable applications to run or content to download from the server or elsewhere on the wireless network, and transferring selected applications and/or digital content to the wireless device. Provisioning also involves the troublesome function of ongoing monitoring of the digital content and determining charges or billing for accessing or using the digital content.

In current provisioning systems, digital rights of a user to content (e.g., such as licensing of digital content) delivered via the Internet and other digital means is often unmanaged or at best, poorly managed. In some systems, once the content has been delivered to a wireless device, digital rights are controlled or enforced by built-in encryption technology that limits the user's access and use of the content, which is a static or one-time approach to access or digital rights management that typically does not allow ongoing or real-time digital rights management by the user or by the content or service provider. More recently, content providers have begun demanding the ability to more effectively perform digital rights and content management activities such as mining data to determine customer digital content usage patterns and controlling digital rights (such as adding users or subscribers to a particular digital content or revoking previously granted rights). Managers of digital rights often want to have flexibility in the granting of rights to content such as by providing digital rights as part of a promotion or as part of more complex licensing or subscriber arrangements (e.g., per a rights rule or set of rules provided by a content provider such as “If the user has subscribed for the gold plan and their buddy list has exceeded a preset number, the user has a predefined set of rights to the content.”).

Users of wireless devices are also beginning to demand more functionality from their wireless devices, including increased ability to manage their digital rights and content. User demand has been driven by the proliferation of content consumption wireless devices, such as cell phones and other mobile devices. These devices have limited capacity for storing content but users are demanding (and service and content providers are selling or distributing) more content than can be stored or used at one time on their wireless device. In general, the user has little or no ability to manage the digital content once they have purchased or otherwise obtained rights to access the content. Users are demanding abilities to share content accessible from their wireless device with wireless devices operated by other users, but presently, there has been little progress in this area of the wireless communication industry. The wireless device user presently has difficulty in determining which digital rights they have obtained and has difficulty updating or changing such as rights, accessing or managing the content for which they have rights, and sharing such content.

Existing content provisioning systems and “vending machines” have not successfully addressed the demands of the service and content providers or the wireless device users. A number of content provisioning systems implement simplistic authorization systems for controlling access by users to content but typically do not facilitate management of rights by the user or the service provider and simply store content in LDAP (Lightweight Directory Access Protocol) directories or in databases. Digital rights management is often tied to or specific to the content being accessed or controlled or tied to the rights enforcement mechanism employed by the provisioning system or vending machine. Billing for digital content has been difficult to manage with existing billing techniques typically involving a one time download fee or an ongoing subscription charge for access to content (i.e., present billing systems are often not related to actual use and are simplistic in nature thus not facilitating promotional programs such as rate reductions for referrals or sharing of content with other users).

Hence, there remains a need for an improved method and system for use in wireless device provisioning systems for managing digital rights to content and managing the digital content itself. Preferably, such a method and system would enable a service provider to actively manage users' digital rights including obtaining information on content usage and user activity patterns and enable wireless device users to manage their digital rights and content. Such a method and system would preferably not be dependent on particular device configurations, on network or communication protocols, or specific digital content and would preferably be useful with typical resource-constrained wireless devices.

### SUMMARY OF THE INVENTION

The present invention addresses the above problems by providing a provisioning system for a wireless content distribution system that is configured with a number of components (i.e., a “digital rights locker” mechanism) that enhance digital rights and content management. The digital rights locker mechanism provides for the management of digital rights by both a carrier (or other content or service provider) and an end user (i.e., a user or operator of a client wireless device) and provides a central storage location for at least clients digital rights (i.e., client rights profiles) and often for a link to clients' content as well as the content itself (such as in a content repository). While the digital rights locker mechanism can be provided as a standalone device (such as on a separate server), the mechanism is typically provided as an added component(s) to a larger system such as part of a provisioning system that is part of a wireless content distribution system. The mechanism is generally independent of any particular rights enforcement technology, of any specific content or content format, or of a particular wireless network, communication protocol, and content transfer or external adapters for interfacing with wireless devices as well as content providers and carriers or service providers.

The digital rights locker mechanism interacts with a number of distribution and/or provisioning system components to enhance rights and content management. The mechanism functions to organize digital rights based on input and actions taken by the end user. For example, the user requests discovery of available content via the provisioning system and completes a purchase, subscription, licensing, or other content addition transaction. The digital rights locker mechanism then acts to update the user client rights profile stored in memory or storage and updates a client registry that provides a link between the user and their personal digital content (e.g., content for which the user has certain access rights). The user may also query the content registry to identify the content that is presently accessible by them. If use is requested, a rights granting mechanism (e.g., useful enforcement technology) determines if the user currently has the appropriate rights to download or otherwise use the content from a content repository (e.g., storage for the content that is part of the provisioning system, a directory to the content that is stored on various content provider systems that are networked to the provisioning system, and other useful content storage and access arrangements).

The user may also manage their current client rights profile maintained by the locker mechanism, such as via a graphical user interface displayed by the mechanism on their wireless device, and such user management may include terminating a subscription, sharing content (if appropriate rights are in place) with other users, and referring content to other users. The locker mechanism also enables rights management by the carrier or service provider by mining data from the client rights profiles to report existing content and digital rights and, in some cases, monitored usage of content and reporting such mined data to the carrier. The carrier, such as via a graphical user interface displayed by the locker mechanism, can manage the digital rights and content by terminating subscriptions of clients by modifying their client rights profile (such as for failure to make payments or violating a license agreement), by providing promotional digital rights to new content (such as in response to a user making a number of referrals, to promote new content, and other reasons), and by adding new content to the content repository.

The digital rights locker mechanism includes a number of functional elements to provide the desired management functions of the invention. For example, external adapters are included to implement external interfaces of the digital rights locker mechanism (or of the provisioning system) with wireless devices (which may vary widely in configuration) and with carriers, content providers, and the like and may include Web service interfaces, remote method invocation (RMI) interfaces, remote procedure call (RPC) interfaces, and human-oriented interfaces such as hypertext markup language (HTML) pages. The mechanism includes (or has access to) long-term storage to store information useful for granting digital rights and the information may include the client rights profiles and access or rights rules provided by content providers and/or carriers. A rights granting mechanism is provided to respond to a user request for access to content by determining what information is necessary for granting the right to use the content and processing such information. Typically, the rights granting mechanism grants rights or access to content based on the client rights profile for the requesting client and based on a default or hard-coded rights enforcement rule or on a rule or rule set that is supplied by an external entity (such as the carrier or content provider) and that can be dynamically updated without changing the rights granting mechanism.

More particularly, a computer-based method is provided for enhancing management of digital rights in a provisioning system. The method includes providing a set of digital content elements that are accessible from a wireless network. Profiles for a plurality of wireless devices are stored in a central repository. The profiles include information that defines the access rights of the wireless devices to the digital content elements. The method continues with receiving a discovery request from one of the wireless devices based on their digital rights information in their profile. In response to the discovery request, a portion of the digital rights information is retrieved and displayed on the requesting wireless device. In some embodiments, the response to the discovery request includes retrieving a listing or identification of portions of the content for which the requesting wireless device has existing access rights. The method may then include receiving an update request from the wireless device to update the access rights and in response, updating the profile information for that wireless device. Additionally, a content action command or request may be received from the wireless device requesting that a specific action (such as sharing the content or referring the content) is taken for a portion or element of the content. The specific action is taken after it is determined that the digital rights for that portion of the content supports or allows the requested action.

### BRIEF DESCRIPTION OF THE DRAWINGS

FIG. 1 illustrates in block diagram form a wireless content distribution system according to the present invention showing exemplary components of a content provisioning system that functions to enhance management of digital content and digital rights by users or clients and by carriers;

FIG. 2 is a flow chart illustrating functions performed during a content distribution process of the present invention and more particularly, processes involved in managing digital rights and digital content in a provisioning system such that shown in FIG. 1; and

FIG. 3 illustrates a simplified wireless content distribution system similar to the system of FIG. 1 showing the use of multiple content provisioning systems and corresponding rights control and management components along with multiple wireless networks and carriers.

### DETAILED DESCRIPTION OF THE PREFERRED EMBODIMENTS

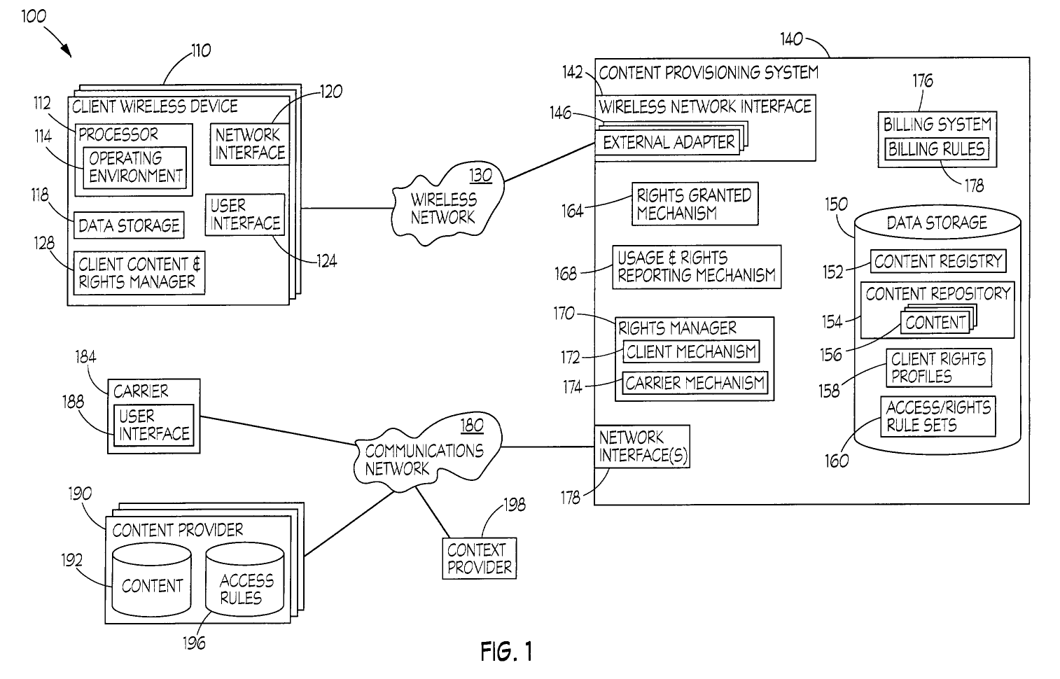

In the following discussion, computer and network devices, such as client provisioning system 140, carrier 184, and content provider 190 of FIG. 1, and client devices, such as client wireless devices 110, are described in relation to their function rather than as being limited to particular electronic devices and computer architectures. To practice the invention, the computer and network devices may be any devices useful for providing the described functions, including well-known data processing and communication devices and systems such as personal digital assistants, personal, laptop, and notebook computers with processing, memory, and input/output components, and server devices configured to maintain and then transmit digital data over a communications network. Similarly, the wireless client devices may be any electronic or computing device for transmitting digital data over a wireless network and are typically, but not necessarily, resource-limited devices such as TV set-top boxes, Internet TVs, Internet-enabled screenphones, automobile entertainment and navigation systems, cell phones, pagers, personal organizers, and the like. Data, including client requests, service provider or carrier and content provider requests and responses, and transmissions to and from the content provisioning system, typically is communicated in digital format following standard communication and transfer protocols, such as TCP/IP, HTTP, HTTPS, FTP, IMAP and the like, or IP or non-IP wireless communication protocols such as TCP/IP, TL/PDC-P, WSP, Bluetooth, 802.11b, and the like, but this is not intended as a limitation of the invention. Additionally, the invention is directed toward the management to rights to content and the management of the content itself. Content is intended to be a relatively generic term covering nearly all forms of digital information that may be provided over a wireless network to wireless communication devices, such as applications, Web services, ring-tones, and data applicable to the applications and services or otherwise useful by the devices (such as JPEG backgrounds and the like).

FIG. 1 illustrates an exemplary wireless content distribution system 100 incorporating a content provisioning system 140 that is configured according to the invention to enhance user and service provider management of digital content and digital rights to such content. The system 100 includes a number of client wireless devices 110 linked to the content provisioning system 140 via a wireless network 130 (e.g., a circuit-switched data (CSD), packet-switched data (PSD), or other type of wireless data network). The content provisioning system 140 is also in communication with a carrier or service provider 184 for the wireless network 130 and a number of content providers 190 via a communications network 180 (such as the Internet, a WAN, a LAN, and the like). As will become clear, during operations, the content provisioning system 140 communicates with the client wireless devices 110 to allow the devices 110 to discover new content, to obtain new rights or modify existing rights to content (new and previously existing) that is stored on the system 140 or accessible through the system 140, and to access content for which it has rights to use the content on the device 110 or to share or refer the content with other devices 110. The content provisioning system 140 further acts to gather content from content providers 190 (or to obtain links and remote access capabilities to content) and to communicate with carrier 184 (or other service providers) to allow the carrier 184 to monitor content usage by client wireless carrier devices 110 and to monitor and manage rights to content provided to the devices 110. Further, the provisioning system 140 can function to monitor client digital rights and content usage for use in billing or charging user of the devices 110 for such rights and content usage.

Each client wireless device 110 is configured for communicating with digital messages over the wireless network 130 and using at least some quantity of content deliverable by the content provisioning system 140. The configuration of the device 110 is not limiting to the invention and may vary significantly with each device including different resources and often utilizing different networking technologies and standards (e.g., similar to wireless devices presently being manufactured and distributed in the marketplace). Generally, each client wireless device 110 includes a processor 112 (such as a 16-bit, 32-bit, or other processor) running or providing an operating environment 114, which may include a host operating system, native applications, OEM-specific applications, and more specific configuration or standardization software (such as a Java virtual machine based on the Connected, Limited Device Configuration (CLDC) and associated libraries) and a set of application programming interfaces (APIs) such as those defined in the mobile information device profile (MIDP) specification.

A limited amount of data storage 118 (including persistent storage) is provided with some portion (such as 160 to 512 kilobytes or more) being available for content provided from the content provisioning system 140. A network interface 120 is provided to connect the device 110 to the wireless network 130 such as a wireless intermittent connection with limited bandwidth (such as 9600 bps), and in some cases, a wired connection or infrared connection may also be provided for connection to other devices or to the communications network 180. A user interface 124 is provided to display data to a user of the device and to allow the user to input data, and as such the interface 124 may include a display screen for displaying received data and data being input on a graphical user interface (such as that created by the content provisioning system 140) and input devices (such as a keypad, a keyboard, a touch screen, and/or other input mechanisms). Each client wireless device 110 typically also will include (to run persistently or on an as-needed basis) a client content and rights manager 128 that may be an application or other code mechanism that allows the client wireless device to interface with the content provisioning system 140 (such as a MIDP, a microbrowser, or other application for interfacing with the rights granting mechanism 164 or rights manager 170 of the system 140). The client content and rights manager 128 may be configured for discovering or searching the content provisioning system 140 (such as by searching a locator or URL of the content provisioning system 140 via the wireless network 130) for available content and for personal content (e.g., content which digital rights have already been obtained) and for requesting to manage the content or client rights by accessing and modifying a client rights profile (see profiles 158 in system 140).

The content provisioning system 140 includes components that work in combination as a “digital rights locker” mechanism or system to allow users of the client wireless devices 110 to browse, arrange, delete, forward to other devices 110, and otherwise manage content and corresponding digital rights. Similarly, the carrier 184 (and in some cases, the content providers 190) is able to manage client digital rights and content as well as manage or control billing for content usage and mining of client profile (e.g., usage) data. A wireless network interface 142 is provided for communicating content and messages over the wireless network 130 with the devices 110 and includes external adapters 146 (or provisioning adapters) for communicating according to standards and/or protocols expected by the various devices 110. A network interface(s) 178 is provided to allow the content provisioning system 140 to communicate with carrier 184 and content providers 190 via the communications network 180 and, as such, may include separate interfaces for the carrier 184 and for all or each of the content providers 190 that are adapted for the communications network 180 and configurations of the carrier 184 and content providers 190.

The content provisioning system 140 illustrated is adapted to provide a central location for storing content obtained by the users of the content wireless devices 110 (i.e., for which digital rights have been purchased or otherwise obtained), to allow the users to browse and manage such content, and to provide each user with an identity or profile and a link between the users and the content. As shown, data storage 150 is provided for long-term storage. The data storage 150 can be part of the system 140 as shown or be any useful memory or data storage device accessible by the content provisioning system 140. A content repository 154 is provided to store the content available from the content provisioning system 140, which is provided via the communications network 180 from the content providers 190 (e.g., third party developers of content 192). The content 156 in the repository needs to be discoverable by the devices 110, and the content registry 152 is provided as a directory (such as a LDAP directory) of the available content in the system 140.

For each client wireless device 110 (or at least those subscribing to or served by the system 140), a client rights profile 158 is stored in the data storage 150 including information on digital rights previously obtained by a user of the device 110 and, in some cases, additional profile information such as referral information for content, trading or sharing information of the content with other devices 110, and usage of the content 156 for which digital rights have been obtained. A rights manager 170 is provided with a client mechanism 172 for enabling each client wireless device 110 to access the client rights profiles 158 and to modify the information of the profile 158 to manage their digital rights (such as by terminating a subscription, trading rights, or sharing content). In some embodiments or operational configurations of the system 100, all or portions of the content 156 may remain as content 192 stored at the content provider (or at yet another point or server in the system 100) with only the client rights profiles being stored at the provisioning system 140. In these embodiments, the provisioning system 140 still controls access to and delivery of the content 192 based on the client rights profiles 158 but storage (or at least long-term or persistent storage) is not provided in the system 140.

The client mechanism 172 may create a user interface or graphical user interface that is displayed on the user interface 124 of the device 110 for displaying profile data (e.g., rights data) and for receiving user update information to change or manage the digital rights. In this manner, the user is able to quickly determine the rights they have and to update or change such rights as desired. A carrier mechanism 174 is also provided in the rights manager 170 to allow the carrier 184 to view client rights profiles 158 (such as via a GUI displayed on the user interface 188), to manage the rights such as by terminating licenses or providing additional rights, and to obtain usage information. To assist in mining user data, a usage and rights reporting mechanism 168 is provided to monitor content usage and/or to process (ongoing or periodic) the client rights profiles 158 to capture usage information, referral information, and sharing information which is then reported to the carrier automatically or upon request via the communications network 180.

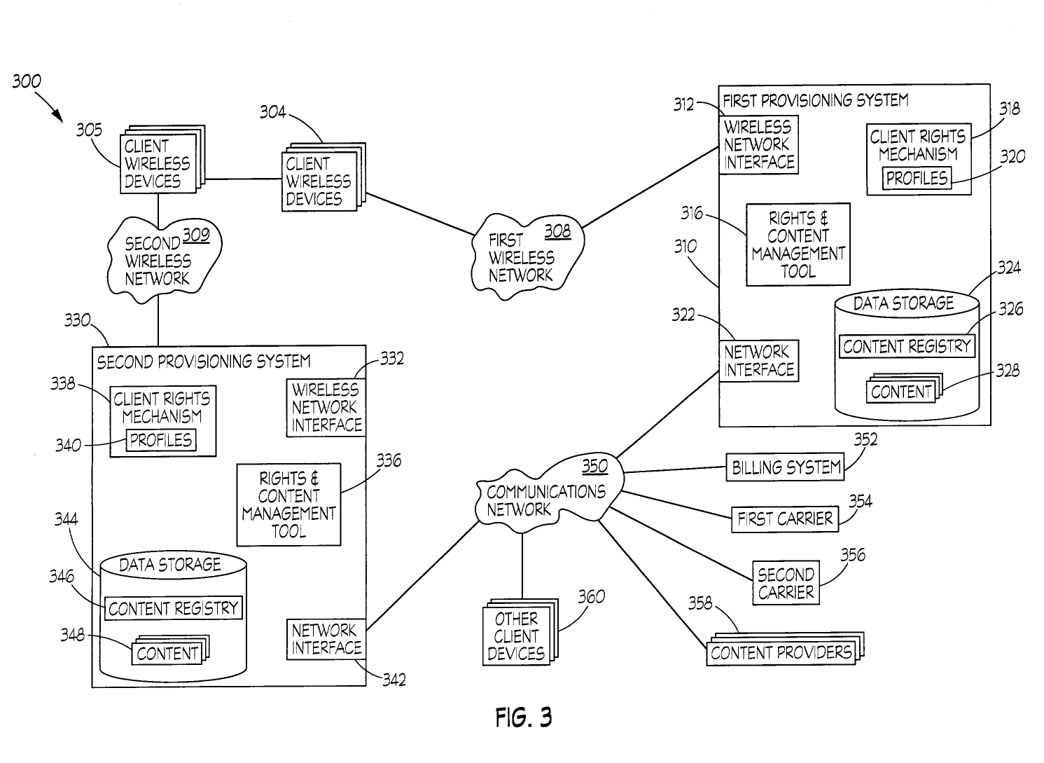

A link between the client digital rights and the corresponding content is provided by the system 140. This can be provided in a number of ways. For example, a logical link to content 156 can be provided as part of the client rights profiles 158. Such an arrangement is particularly useful if the amount of content 156 that each user has rights to is expected to remain small. This arrangement strongly couples content 156 to the user device 110 but loosely to the actual or current content 156 in the repository 154, which results in frequent updating of the content links as the content 156 is updated, deleted, or otherwise becomes stale. In one preferred embodiment (such as system 140), a logical link between content 156 and devices 110 which have digital rights to access that content 156 is provided directly in the content registry 152. This is a desirable arrangement for keeping the content-user device link information close to other metadata associated with the content 156. Such a configuration is useful when a user provides a request to discover their digital rights (i.e., provides a query as to “what content do I have?”) and also then ask further or deeper questions about a specific element of content 156. In these two configurations, the content-user device link information is provided on one system, i.e., the data storage 150, but in other embodiments (such as that shown in FIG. 3), a separate component is utilized for storing such link information and profile information to allow ready modification of such link information and make it more efficient and clean to build additional services on the profiles directory 158 such as profiling, referral incentive programs, and the like, on the separate component.

The content provider 190, such as a third party application developer, develops and delivers content 192. The content provider 190 can also create access rules 196 for such delivered content 192, which are stored in data storage 150 as access or rights rule sets 160. A rights granting mechanism 164 is provided in the content provisioning system 140 to enforce default or hard-coded rights enforcement rules or, if received for the particular content 156, applying the access or rights rules 160 to a request for content 156 from a device 110. A number of enforcement technologies may be implemented as part of the rights granting mechanism 164 that basically processes a content request from a device 110 to retrieve an appropriate client rights profile 158 and then compare digital rights for the content 156 identified in the request. If available, access rules 160 are applied to make the enforcement decision of whether the device 110 has the rights to access the content 156 for the purpose indicated in the request. The rule set 160 can include relatively complicated logic such as requiring that the user profile information in the rights profile 158 for the requesting device 110 indicates the user is a subscriber of (or has a license to) the content 156 plus has made a number of referrals within a certain time period and has not accessed the content more than a maximum number within a given time period (i.e., almost any combination of requirements can be combined in the rule sets 160).

A billing system 176 is provided in the content provisioning system 140 with billing rules 178 established for the provisioning system 140, set by the carrier 184, or content specific and set by the content providers 190. The billing system 176 can be configured to receive usage messages from the other components of the system 140 (such as rights granting mechanism 164 for charges based on accessing content, such as the content repository for per download or use fees, and/or such as from the usage and rights reporting mechanism 168 for periodic billing based on usage data in the profiles 158). The billing system 176 can be flexible to allow more than just initial billing for obtaining digital rights but also for per use charges. Additionally, the billing rules 178 can be configured to provide users with referral and trading content incentives such as by reducing fees based on such referrals and trades and/or based on a desired level of content usage by the user of a device 110.

As shown, a context provider 198 is included in the system 100 to facilitate dynamically or variable construction of the client rights profiles 158 during operation of the system 100. For example, in several embodiments of the system 100, it is useful for the client rights profiles 158 to be created in real time based on operations or locations of the wireless devices 110. In some embodiments, more than one client rights profiles 158 is provided for devices 110 with each profile 158 being used by the provisioning system 140 based on the operation and/or location of the devices 110. In this manner, the digital rights components of the system 140 allow the profiles 158 to be dynamically constructed from stored data, stored rules, and/or, significant to context provider 198, externally obtained data. Hence, for some devices or for some content, the profiles 158 may be relatively static information while for others the profiles are created as part of the provisioning or content access operations.

The context provider 198 is linked to the content provisioning system 140 via communications network 180 and acts to provide additional information pertaining to one or more of the wireless devices 110 to the system 140 for use in creating the client rights profile 158 for that device 110. In one embodiment, the additional information includes location information for the client wireless device 110 and the context provider 198 is configured to determine the location of the device 110 (such as by processing a global positioning satellite (GPS) signal from the device 110). The device location information is the available to the content provisioning system 140 in dynamically creating or modifying the client rights profile 158 for the device based on this additional device information (i.e., location information).

For example, a user of a device 110 may bring their device 110 to a specific physical location, such as a shopping mall, a particular city, a corporate facility, and the like, and request content based on their location. In one embodiment of the system 100, the content provisioning system 140 responds to the discovery request from the client device 110 by contacting the context provider 198. The context provider 198 acts to determine the location of the requesting device 110 and returns this information to the content provisioning system 140. The content provisioning system 140 then utilizes this information (such as via the rights granting mechanism 164 or other components) to dynamically create (or modify an existing profile 158) a client rights profile 158 based on the device location information. The profile 158 may include other information for the device 110 such as personal information, usage information, previously obtained rights to content (e.g., has the wireless device already obtained rights for this location or usage defined by the additional information provided by the context provider 198), and other information that may be useful in determining digital rights to content that is specific to the location of the device 110. In some embodiments, the new profile created based on location is marked as a temporary profile for the device 110 and is stored in temporary storage separate from the data storage 150 (or later deleted from the profiles 158 as location changes or as part of a periodic optimization of storage 150).

In operation of the system 100, the client device 110 now has a location-based profile 158 and the provisioning system 140 may display this profile information on the device 110 or more typically, will respond to the discovery request by providing the device 110 with direct access to appropriate content based on their profile 158 or display a listing of available content 156 that is specific to the location. In a shopping mall example, the device 110 would transmit a discovery request to the provisioning system 140 which would respond by creating a user profile based on a location provided by the context provider 198 and then providing the profile 158 to the user device 110 and/or content available 156 related to the shopping mall. Once the device 110 is removed from the shopping mall and another discovery request is made (or request to view profile 158), the provisioning system 140 acts to determine the location of the device 110 via the context provider 198 and creates a different profile 158 that (typically) will not include digital rights to information regarding the shopping mall. The new or different profile 158 may be a relatively persistent base or default profile 158 stored in data storage 150 for the device 110 or again may be a location-specific or other additional information-specific profile that is created for the device 110. In this manner, the system 100 is operable to allow a user to obtain differing digital rights (based on location or other additional information) based on their varying uses of the device 110.

A location service is just one example of the information that may be provided by the context provider and the invention is intended to cover numerous other new or legacy information that may be provided by a third or external party to the provisioning system 140 for use in dynamically creating the client rights profiles 158. For example, the context provider 198 may be adapted to determine for client wireless devices 110 used in vehicles (such as automobiles) whether the device 110 is moving and if moving, at what speed. This movement and/or speed information can then be used by the content provisioning system 140 to develop the client rights profile 158 for the device 110 and content rights may depend on such information (e.g., provide visual and text information when not moving or at a cruising speed while providing access to audio and/or light text or visual content when moving at speeds indicating city driving to reduce distractions). The context provider 198 may also store and provide legacy information such as a prior usage or usage patterns or purchased rights plans (such as purchased levels) that can be used by the provisioning system 140 in generating the client rights profiles and/or for controlling access to content 156 with the rights granting mechanism 164. As can be appreciated, the type of real-time or legacy information provided by the context provider 198 is not limiting to the invention with a wide variety of information being useful for embodiments of the system 100 in which profiles 156 are dynamically created. Additionally, while one context provider 198 is shown for simplicity, the system 100 may include a plurality of context providers 198 which may act alone or in combination with other context providers 198 and/or legacy systems (not shown).

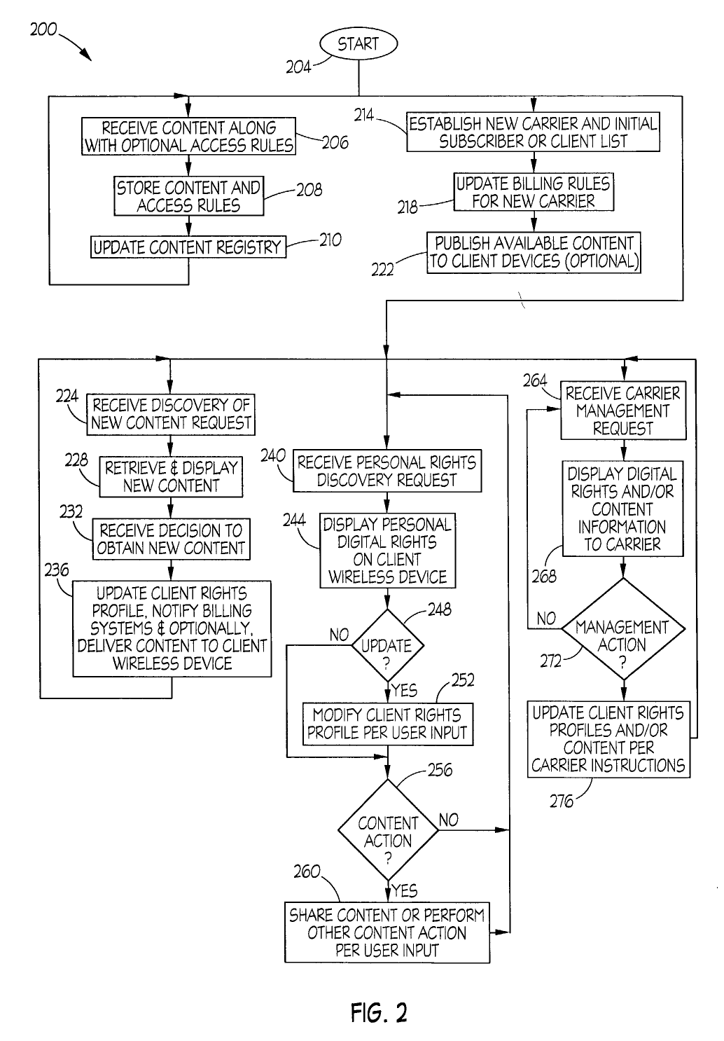

FIG. 2 illustrates a digital rights and content management process 200 according to the invention that can be provided as part of operation of wireless distribution systems, such as system 100. The process 200 starts at 204 typically with providing and configuring a content provisioning system 140 with digital locker mechanism components (such as one or more of rights granting mechanism 164, usage and rights reporting mechanism 168, rights manager 170, and a data storage system 150 with a content registry 152, a content repository 154, and client rights profiles 158). The provisioning system 140 is linked to the wireless network 130 and the communications network 180 to link the system 140 to client wireless devices 110, carrier 184, and content providers 190. The functions or steps of the process 200 may be performed in differing orders than those shown in FIG. 2 and many of the functions or steps or groups of functions or steps are typically performed concurrently as shown.

At 206, the content provisioning system 140 receives content 192 via the communications network 180 and network interface 178 from a content provider 190. Along with the content 192, access rules 196 for such content 192 may optionally be provided by the content provider 190 for use by the rights granting mechanism 164 in enforcing access or digital rights when access is requested by users of the devices 110 to the content 192. At 208, the content 192 is stored in a content repository 154 as available content 156 and the access rules 196 received are stored as access and rights rule sets 160 in the data storage 150. At 210, the content registry 152 is updated to reflect the addition of new content. Steps 206-210 are then repeated upon the receipt of new content and modifications or updates to the content 156 (including deletions of content 156).

At 214, the process 200 continues with establishing a new carrier 184 or configuring the provisioning system 140 for the carrier 184. Such initiation 214 may include establishing a number of client rights profiles 158 based on an existing subscriber list of the carrier 184 including importing or storing in profiles 158 profile information including digital rights to content 156. In some embodiments, the content registry 152 is updated to modify the content-to-user device link information (or this may be provided in the client rights profiles 158 information). The carrier 184 may input or provide billing rules 178 and these are stored at 218. These billing rules 178 are utilized by the billing system 176 in tracking charges or fees for services provided by the provisioning system 140 (such as initial granting of rights to content, per use charges, and the like) based on the billing rules 178. At 222, the content provisioning system 140 can optionally publish or advertise available content 156 to all or a portion of the client wireless devices 110 (such as by e-mail messaging of content lists). Such a publishing 222 may also be performed upon the receipt or updating of content 156 at steps 206-210.

At 224, a user of a device 110 transmits a discovery request to determine what content 156 is available for the device 110 to get digital rights (such as with client mechanism 172). At 228, the content registry 152 is accessed by the client mechanism 172 or directly by the client wireless device 110 to identify the content 156, such as in a directory listing, and this listing or other content identification information is displayed on the user interface 124. At 232, a decision or request to obtain digital rights to a portion of the content 156 is received by the rights manager 170 (optionally, along with a form of payment that is transmitted to the billing system 176). At 236, the rights manager 170 updates the client rights profile 158 corresponding to the requesting client wireless device 110, the billing system 176 is notified (to initiate up front billing and/or to initiate ongoing per use or other usage-based billing programs), and the content-to-user device link information is updated (either in the profile 158 or in the content registry 152). Optionally, at 236, the requested content 156 can be downloaded or provided to the wireless device 110.

At 240 (which can occur concurrently with 224-236), a client wireless device 110 transmits a request for access or discovery of their previously obtained digital rights. The client mechanism 172 of the rights manager 170 acts to process the request and retrieve information from the client rights profile 158 corresponding to the device 110. The retrieved rights information is displayed (such as on a GUI) on the user interface 124 of the device 110. In some cases, the client rights profile 158 is dynamically created at this point in the process 200 based on additional device information provided by the context provider 198 (such as a current location of the device 110), as explained in detail with reference to FIG. 1.

The user can then operate the user interface 124 to browse their digital rights and if desired, to transmit an update request for the digital rights, such as terminating a subscription. At 248, the client mechanism 172 determines if an update request or input is received. If an update is received, at 252, the client rights information is updated and stored in the client rights profile 158. As part of such updating at 252, the content-to user device link information is typically also updated in the profile 158 or the content registry 152.

The user at 256 may also indicate via user interface 124 (such as in input boxes) that they wish to perform a content action, e.g., perform actions allowable or acceptable based on a corresponding digital right. If a content action request is detected at 256 by the client mechanism 172, the process 200 continues at 260 with performing the requested content action (such as sharing the content with other devices 110, referring the content to other devices 110, and the like). At this point, the rights granting mechanism 164 determines whether the requested content action can be carried out based on the requesting devices digital rights to the content 156 and based on default access rules or access rules 160 provided by the content provider 190 (or carrier 184). If it is determined that rights correspond to or match the requested action, the content action is taken (such as by sharing the content with another device 110).

At 264, the provisioning system 140 receives a request from the carrier 184 to access and manage digital rights granted to the clients 110 (and in some cases, content 156). The carrier mechanism 174 of the rights manager 170 acts at 268 to process the client rights profiles 158 and display digital rights granted to clients 110 such as on a GUI on user interface 188 of the carrier system 184. If a management action is detected at 272, the process 200 continues at 276 with the carrier mechanism 174 acting to update the client rights profiles 158, such as by terminating a license for non-payment or by adding rights or modifying rights. In some embodiments, content 156 via the registry 152 is viewable by the carrier 184 at user interface 188 and is also manageable or controllable by the carrier 184. If a content management action is detected at 272, the content action is performed at 276 followed by an updating as necessary of the content 156, the content registry 152, and the client rights profiles 158.

FIG. 3 illustrates another embodiment of a wireless content distribution system 300 according to the invention. The system 300 differs from system 100 in that first and second wireless networks 308, 309 are operated for client wireless devices 304, 305 by first and second carriers 354, 356. To manage content and rights for the different networks 308, 309, first and second provisioning systems 310, 330 are linked to the devices 304, 305 via wireless networks 308, 309 and to carriers 354, 356 via communications network 350. As with system 100, content providers 358 are linked to the communications network 350 to provide content (and, in some cases, access rules) to the provisioning systems 310, 330. In contrast to system 100, system 300 provides a single billing system 352 as a separate component linked to the provisioning systems 310, 330 for servicing both provisioning systems 310, 330 and/or both carriers 354, 356. Additionally, other client devices 360 are linked to the communications network 350 and may be other computing devices (such as an office PC or home laptop) operated by the users of the wireless devices 304, 305 or by other operators with or without wireless devices. During operation of the system 300, client wireless devices 304, 305 can request the provisioning systems 310, 330 to share content for which they have rights with the other client devices 360. In this manner, the resource, constrained devices 304, 305 can download or transfer larger sized or resource demanding content to more powerful devices 360 for more effective use of their digital rights.

The provisioning systems 310, 330 include wireless network interfaces 312, 332 and communications interfaces 322, 342 similar to system 100. The components of a digital locker mechanism are shown more consolidated with the inclusion of rights and content management tools 316, 336. The tools 316, 336 provide the functions of the rights granting mechanism 164, the usage and rights reporting mechanism 168, and the rights manager 170 of provisioning system 140.

Additionally, in some embodiments, the first and second provisioning systems 310, 330 work at least partially as a federation or in a combined effort to manage content and digital rights. In these embodiments, the tools 316, 336 are configured to discover other provisioning systems 310, 330 with rights and content management tools 316, 336 (e.g., operating under digital locker principles) and form a trusted relationship or federation. This arrangement is particularly useful when one or more of the devices 304, 305 utilizes more than one provisioning system 310, 330 (as may be the case when multiple provisioning systems service a single wireless device or a user operates more than one client wireless device 304, 305 on multiple wireless networks 308, 309 in which case a user may not be required to obtain repetitive digital rights). In the federation arrangement, the first and second provisioning systems 310, 330 can use their management tools 316, 336 to respond to content requests from devices 304, 305 and if the device is not in their profiles 320, 340, transmit the request to the appropriate provisioning system 310, 330 (optionally, a provisioning system identifier can be included in communications from the devices 304, 305). In this manner, the digital locker concepts of the invention can be utilized in a wireless content distribution system 300 with distributed provisioning systems 310, 330. Such federation and linking of provisioning systems 310, 330 is also useful for allowing one provisioning system 310, 330 to sell or distribute digital rights to content on the other provisioning system 310, 330. In this fashion, the system 300 can be constructed to position the point from which content is distributed as close to the user devices 304, 305 as possible (with “close” being defined in terms of network bandwidth, latency, and topology) such that rights may be managed by a more distant or remote provisioning system 310, 330 while content is distributed from the more local or close provisioning system 310, 330.

In the provisioning systems 310, 330, data storage 324, 344 is provided for storing content 328, 348 provided by the content providers 358 and with content registries 326, 346 providing a discoverable index or listing of the content 328, 348 and its location in data storage 324, 344. Again, a content-to-user device link may be indicated in the content registries 326, 346 or alternatively, within a user's locker profile. In the illustrated provisioning systems 310, 330, separate client rights mechanisms 318, 338 are provided which provide some of the functions of the client mechanism 172 of system 140 in FIG. 1 and which further include the user's client rights profiles 320, 340 for the devices 304, 305. The profiles 320, 340 may include the content-to-user device link information or in some embodiments, the link information is provided as a separate component (not shown) that may be part of the client rights mechanisms 318, 338 or a separate component within the systems 310, 330. Such separation of the links information may be warranted when the profiles 320, 340 and the registries 326, 346 are in use or existing prior to initiation of the provisioning system 310, 330 for digital locker operations. Additionally, such separation provides a clean point for managing the many-to-many links between the users and the content 328, 348 and does not complicate the profiles 320, 340 or the registries 326, 346.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

For example, it will be understood that in some cases the wireless devices 110, 304, 305 may be able to obtain content from devices other than from the provisioning systems 140, 310, 330 (such as by infrared or hardwired connections). In such cases the systems 100, 300 can be adapted such that this additional content is transferred to the provisioning systems 140, 310, 330 from the wireless device 110 (or from the content source) typically via a communication network such as the Internet 180, 350 but in some causes over the wireless network 130, 308, 309 (such as when the volume of the content is small or the provisioning system 140, 310, 330 is “close”).

We claim:

1. A computer-based method for provisioning digital content to wireless devices over a wireless network, comprising:
providing a set of digital content elements accessible from the wireless network;
storing profiles for a number of wireless devices, wherein the profiles include information defining the digital rights of the wireless devices to the digital content elements; and
receiving a discovery request from one of the wireless devices based on the digital rights information in the profile corresponding to the one wireless device.

2. The method of claim 1, further including responding to the receiving of the discovery request by retrieving a portion of the digital rights information based on the discovery request and displaying the retrieved portion on the one wireless device.

3. The method of claim 2, wherein the retrieved portion includes the digital rights definition information for the one wireless device.

4. The method of claim 3, further including receiving a digital rights modification request from the one wireless device and in response, modifying the digital rights definition information and updating the stored profile for the one wireless device based on the modifying.

5. The method of claim 2, wherein the retrieved portion includes a listing of the content elements corresponding to the digital rights of the one wireless device.

6. The method of claim 5, further including receiving an action request for one of the content elements from the one wireless device and in response, performing the content action request on the one content element based on a portion of the digital rights of the one wireless device corresponding to the one content element.

7. The method of claim 6, wherein the content action is sharing the one content element or transmitting a referral to the one content element.

8. The method of claim 1, further including receiving a discovery request from a second one of the wireless devices for the digital content elements and in response, retrieving and then displaying a listing of at least a portion of the digital content elements on the second one of the wireless devices.

9. The method of claim 8, further including receiving a request for digital rights to one of the digital content elements and in response, updating the digital rights information in the profile for the second one of the wireless devices.

10. The method of claim 1, further including displaying at least a portion of the digital rights information from the profiles on a rights management device, receiving a rights management command from the rights management device, and in response, modifying the digital rights information based on the rights management command.

11. The method of claim 1, wherein the profiles includes wireless device usage information for the digital elements, and further including creating a profiling report based on the wireless device usage information and the digital rights information.

12. A method for enabling a wireless device user to manage digital content and rights to the digital content, comprising:
storing available digital content in a content repository accessible from a wireless network;
providing client rights profiles for wireless devices having access to the wireless network, the client rights profiles defining access rights to a personal portion of the digital content for each of the wireless devices; and
receiving a use request from one of the wireless devices for the personal portion of the available digital content for which the one wireless device has the defined access rights.

13. The method of claim 12, further including in response to the use request receiving, processing the use request based on a set of access rules and on the defined access rights for the one wireless device to determine whether to allow a use defined in the use request.

14. The method of claim 13, wherein the set of access rules are received prior to the processing from a provider of the personal portion of the available digital content.

15. The method of claim 12, further including providing a content registry for the stored available digital content with an entry for each element of the available digital content.

16. The method of claim 15, further including providing a link between the access rights of the wireless devices and the available digital content.

17. The method of claim 16, wherein the links are provided in the entry for the elements of the available digital content.

18. A digital content provisioning system, comprising:
a storage device storing digital content and providing a registry to the stored digital content;
a set of client rights profiles defining access rights to the stored digital content for a plurality of wireless devices; and
a rights manager device comprising a client mechanism displaying a client manager interface based on one of the client rights profiles on the wireless device corresponding to the one client rights profile.

19. The system of claim 18, wherein the rights manager device further includes a carrier mechanism adapted to provide a carrier system with access to the client rights profiles and to update the access rights in the client rights profiles based on input from the carrier system.

20. The system of claim 18, wherein the client rights profiles further includes usage information for the stored digital content and further including a reporting mechanism adapted for processing the client rights profile to obtain the usage information and for generating a content usage report based on the obtained usage information.

21. The apparatus of claim 18, further including a rights granting mechanism for processing an access request for the digital content from one of the wireless devices and prior to granting the access request, enforcing a set of access rules based on the access rights of the one wireless device.

22. A method for enabling a wireless device user to manage digital content and rights to the digital content, comprising:
receiving a request from a wireless device over a wireless communication network;
requesting additional information from a context provider for the wireless device;
receiving the additional information from the context provider; and
generating a client rights profile for the wireless device based on the additional information, wherein the client rights profile defines access rights to a set of digital content.

23. The method of claim 22, further including providing at least a portion of the client rights profile to the requesting wireless device.

24. The method of claim 22, further including providing the wireless device with access to the digital content based on the defined access rights.

25. The method of claim 22, wherein the additional information includes location information or speed information for the wireless device.

26. The method of claim 22, further including receiving another request from the wireless device over the wireless communication network and repeating the additional information requesting, the additional information receiving, and the client rights profile generating, wherein the client rights profile generated in the repeated client rights profile generating differs from the original client rights profile.

27. A digital content distribution system for distributing content provided by content providers to wireless devices, comprising:
a first provisioning system in communication with a first set of wireless devices adapted for controlling and providing access to a first set of digital content; and
a second provisioning system in communication with a second set of wireless devices and the first provisioning system adapted for controlling and providing access to a second set of digital content;
wherein the first and second provisioning systems are each adapted to maintain a set of client rights profiles defining access rights to the first or second set of digital content and to operate in response to a content access request from one of the wireless devices by querying the other one of the provisioning systems for information in the client rights profiles maintained by the other one for the wireless device and by using the client rights profile information in the controlling and providing access to the first or the second set of digital content.

28. The system of claim 27, wherein the first set of digital content is stored in memory on the first provisioning system, in memory on the second provisioning system, or in memory on a content provider.
